(19) United States
(12) Patent Application Publication
(10) Pub. No.: US 2014/0263615 A1
(43) Pub. Date: Sep. 18, 2014

(54) MONEY BILL AUTHENTICATION AND THEFT PREVENTION SYSTEM

(71) Applicant: Brian Deangelo, St. Charles, IL (US)

(72) Inventor: Brian Deangelo, St. Charles, IL (US)

(21) Appl. No.: 14/217,023

(22) Filed: Mar. 17, 2014

Related U.S. Application Data
(60) Provisional application No. 61/802,526, filed on Mar. 16, 2013.

(51) Int. Cl. G06K 5/00

(52) U.S. Cl. CPC G06K 5/00
USPC 235/375

(57) ABSTRACT

An authentication system is provided. The authentication system may include an object, predetermined data, an encrypted barcode, an authentication device, a computer and a database. The database may include a plurality of associations between a random unique number and an object and predetermined data thereof. The encrypted barcode may include barcode information, such as but not limited to, predetermined data and the random unique number. The barcode information may be encrypted so that only the database may decrypt. A user may use the authentication device to machine read the encrypted barcode of the object. The authentication device may remotely communicate the encrypted barcode to the database so that the database may perform process steps, including: comparing the barcode information containing a specific random unique numbers with the plurality of associations so as to identify the association having the identical specific random unique numbers; and authenticating whether the association having the identical specific random unique numbers contains identical predetermined data as the barcode information containing the specific random unique numbers. A failure of either identification and or verification may be communicated to the authentication device.

### CROSS-REFERENCE TO RELATED APPLICATION

This application claims the benefit of priority of U.S. provisional application No. 61/802,562 filed 16 Mar. 2013 the contents of which are herein incorporated by reference.

### BACKGROUND OF THE INVENTION

The present invention relates to fraud prevention systems and, more particularly, to a system of registering and authenticating banknotes.

According to the Organization For Economic Co-operation And Development (OECD), “the magnitude and effects of counterfeiting and piracy are of such significance that they compel strong and sustained action from governments, business and consumers. More effective enforcement is critical in this regard.” Current anti-counterfeit methods are insufficient. For example, in the context of banknotes, anti-counterfeit methods include incorporating security components during the paper forming process and or using only a unique type of paper to make the banknotes. However, counterfeiters have been able to reproduce uncanny duplicates of such security components and unique paper.

As can be seen, there is a need for a system of authenticating objects in such a manner whereby the duplication and or reproduction of such objects would be easy to detect, and so enforce.

### SUMMARY OF THE INVENTION

In one aspect of the present invention, a method for authenticating an object, comprises: displaying an optical machine readable code comprising information on the object, wherein the information comprises a unique number and a predetermined data; providing a database comprising a plurality of associations between at least one unique number and the predetermined data linked to each unique number; entering the optical machine readable code into the database; and matching the unique number of the optical machine readable code with the unique number of the database to determine whether the predetermined data of the optical machine readable matches with the predetermined data associated with the unique number of the database.

In another aspect of the present invention, a system for authenticating an object, comprises: a computer having a user interface; and a program product comprising machine-readable program code for causing, when executed, the computer to perform the following process steps: receiving entered information from an optical machine readable code displayed on the object, wherein the optical machine readable code comprises a unique number and a predetermined data; sending the information to a database, wherein the database comprises a plurality of associations between at least one unique number and a predetermined data linked to each unique number; and matching the unique number of the optical machine readable code with the unique number of the database to determine whether the predetermined data of the optical machine readable matches with the predetermined data associated with the unique number of the database.

These and other features, aspects and advantages of the present invention will become better understood with reference to the following drawings, description and claims.

### BRIEF DESCRIPTION OF THE DRAWINGS

FIG. 1 is a forward view of an exemplary embodiment of the present invention;

FIG. 2 is a schematic view of an exemplary embodiment of the present invention; and

FIG. 3 is a flow diagram of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an authentication system. The authentication system may include an object, predetermined data, an encrypted barcode, an authentication device, a computer and a database. The database may include a plurality of associations between a random unique number and an object and predetermined data thereof. The encrypted barcode may include barcode information, such as but not limited to, predetermined data and the random unique number. The barcode information may be encrypted so that only the database may decrypt. A user may use the authentication device to machine read the encrypted barcode of the object. The authentication device may remotely communicate the encrypted barcode to the database so that the database may perform process steps, including: comparing the barcode information containing a specific random unique numbers with the plurality of associations so as to identify the association having the identical specific random unique numbers; and authenticating whether the association having the identical specific random unique numbers contains identical predetermined data as the barcode information containing the specific random unique numbers. A failure of either identification and or verification may be communicated to the authentication device.

Referring to FIGS. 1 and 2, the present invention may include an authentication system 100. The authentication system 100 may include an object 10, predetermined data 12, an encrypted barcode 14, an authentication device 18, a computer 20 and a database 22.

The object 10 to be authenticated may be an item of value, such as a banknote, a check, a withdrawal slip, a tag, a ticket, a document, an identification card or the like. The predetermined data 12 may include information inextricably linked to or with the object 10, such as but not limited to the denomination and serial number of the banknote, a dollar amount and routing number of the check and/or the withdrawal slip, company indicia of the tag, a terms and conditions of the ticket, a serial number of the document, identifying information of the identification card. Identifying information may include first, last and middle name, date of birth, social security number and the like.

The encrypted barcode 14 may be affixed to the object 10. The encrypted barcode 14 may be an optical machine readable code, a human-readable alphanumeric code, a 2D barcode, QR code, matrix code type, a multiple bar code layout, a stacked bar code type, a Microsoft tag, a magnetic stripe or any of a variety of human or machine readable indicia. The encrypted barcode 14 may include barcode information 24, such as but not limited to predetermined data 12 and a random unique number 50. The encrypted barcode 14 may be encrypted so that only the database 22 may decrypt the barcode information 24. The encrypted barcode 14 may be adapted to be machine read by the authentication device 18.

The authentication device 18 may include at least one processor and a form of memory. The authentication device 18 may include a user interface. The processor may include but not limited to, a smart device, such as, a tablet and smart phone. The processor may include a program product including a machine-readable program code for causing, when executed, the processor to perform steps. The authentication device 18 may remotely communicate with the database 22. The authentication device 18 may include a scanning feature adapted to machine read the encrypted barcode 14.

The database 22 may include at least one computer 20 with a user interface. The computer may include any computer 20 including, but not limited to, a desktop, laptop, and smart device, such as, a tablet and smart phone. The computer 20 includes a program product including a machine-readable program code for causing, when executed, the computer 20 to perform steps. The program product may include software which may either be loaded onto the computer 20 or accessed by the computer 20. The software may be accessed by the computer 20 using a web browser. The computer 20 may access the software via the web browser using the internet, extranet, intranet, host server, internet cloud and the like.

The database 22 may include a plurality of associations 26 between each of a plurality of random unique numbers 50 and predetermined data 12 thereof. In certain embodiments, each association 26 may further include information representative of the object 10. The database 22 may be adapted to decrypt any encrypted barcode 14 so as to process all barcode information 24 encrypted therein. The database 22 may be adapted to compare a received random unique number 50 from received barcode information 24 with the plurality of associations 26 so as to identify the association 26 having an identical random unique number 50. Furthermore, the database 22 may be adapted to authenticate whether the association 26 having the identical random unique number 50 includes predetermined data 12 matching predetermined data 12 of the received barcode information 24.

In certain embodiments, the association 26 may include a registered custodian 30 of the particular object 10. The registered custodian 30 may be a bank, a retailer or other entity that has registered with the database 22. The database 22 may be adapted so that only a transaction involving a registered custodian 30 of, say, the ‘XXX’ association 26 may be disassociated or “unregistered” from the ‘XXX’ association 26.

In certain embodiments, the authentication system 100 may include a masking surface 16. The masking surface 16 may be affixed to a portion of the object 10 so as to substantially cover the encrypted barcode 14. The masking surface 16 may be designed to prevent the encrypted barcode 14 from being copied while still allowing the encrypted barcode 14 to be machine read by the authentication device 18.

Referring to FIG. 3, in an authentication process for an object 10, the authentication device 18 may communicate the encrypted barcode 14 to the database 22 (step 110), wherein the database 22 decrypts the encrypted barcode 14 (step 120) so as to process the barcode information 24 for authentication (step 130). The success of the authentication process may be transferred back to the authentication device 18 (step 140).

The method of using the present invention may include the following. The authentication system 100 disclosed above may be provided. A user may use the authentication device 18 to machine read the encrypted barcode 14 of a particular object 10. The authentication device 18 may remotely communicate the encrypted barcode 14 to the database 22. Then the database 22 may perform the step of decrypting the barcode information 24 so as to perform the authentication process disclosed above. Upon failure of the authentication process, the database may perform the step of communicating to the authentication device 18 in use.

In certain embodiments, when authentication may be successful in a bilateral transaction between at least one registered custodian 30, the database 22 may disassociate or “unregister” a registered custodian 30 from the association 26. In certain embodiments, involving a bilateral transaction between a first registered custodian 30 and a second registered custodian 30, the database 22 may change the registered custodian 30 included within a transacted association 26 from the first registered custodian 30 to the second registered custodian 30.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present authentication application discloses a system, the method implemented by that system, as well as software stored on a computer-readable medium and executed as a computer program to perform the method on a general purpose or special purpose computer, are within the scope of the present invention. Further, to the extent the present authentication application discloses a method, a system of apparatuses configured to implement the method are within the scope of the present invention.

In certain embodiments, the encrypted barcode of a money bill may scanned by an authentication device that may be connected to the database. The database may decrypt the encrypted barcode. The database may search the money bill serial number in the database, To locate the record on file in the database, For that money bill serial number to verify that the money bill's specific unique number that may be encoded on the money bill's encrypted barcode matches the specific unique number that may be on file in the database then this may indicate that the money bill may be real.

The money bill serial number may be registered to an electronic battery operated security token and the electronic token may have, A built in LCD display screen, voice recognition microphone and a synchronized security code generator and the security code generator. The security code generator may be synchronized with any system or device to verify an person as an authorized user, Instead of using a regular password and then the authorized user may be granted permission to restricted data or access to a restricted area. If a money bill serial number is registered to an electronic battery operated identity security token then the authorized security token's, Authorized user may be required to speak in to the identity security token's built in microphone. And then the identity security token may generate a security code and the authorized person may be required to enter their identity security token's, Security code to be able to use the money bill with the money bill serial number that is registered to their identity security token.

The present invention may be reconfigured in the following twenty two ways: All twenty two reconfigurations incorporate the use of the electronic identity security token and/or the use of the encrypted barcode, That may have a ID number and a security code encoded on the encrypted barcode that is mentioned in this invention.

In certain embodiments, the money bill anti-theft system may work without the encrypted money bill barcode by entering the money bill serial number in to the money bill anti-theft database system. The money anti-theft system may be used without the encrypted money bill's barcode by retailer's and banks having a money bill serial number or by an person manually enter the money bill serial number in to, the money bill anti-theft system to register and to unregister money bill's from being registered to the retailer or bank in the money bill anti-theft database system.

In certain embodiments, collector money bills that include however not limited to old money bills, money bills with a star in the serial number, uncut money bills and high denomination money bills, The collector money bill may be unregistered out of the money bill anti-theft database at a bank, to make the money bill unusable and then the bank may give the person that is presenting the collector money bill the same face dollar amount of the collectors money bill that may be given to the person with currently used money bills. To allow the person to spend the money and keep the collectors money bill to display, trade or sell. The collector money bills may be reinstated in the money bill anti-theft database if the person pays the face dollar amount of the collector's money bill and pay a small service fee and then the collectors money bill serial number may be reinstated in the money bill anti-theft database.

In certain embodiments, the encrypted barcode that may have a ID number and a security code encoded on the barcode may be used as a tamper seals including however not limited to induction seals on any kind of package or bottle. The same encrypted barcode that may be encoded with a serial number and security code barcode may be printed on a label, sticker, tape, security bags, printed directly on the product or on any other item or thing, the following is a small list of uses that are included however not limited to many other uses that the encrypted barcode may be used on to detect tampering and counterfeiting with including however not limited by crime scene evidence, printed directly on the pills using food grade ink, medication boxes/bottles and shipping box tampering. To detect fake websites that is designed by criminals to appear like a well-known website to steal information the website may have an website id number and an random security code generator that may be synchronized with an encrypted verification website database the website's security code generator may generate,

In certain embodiments, the An security code an person may verify the website as real by accessing an encrypted verification website database and enter the website's id number and the website generated security code. And then the encrypted verification website database may display the registered company name and if the company name is not the company name that the website that makes a person believe that they are at then the website is a fake website that was created by criminals, And the person may be able to report the URL to that website and the company name that the criminals are using may be notified of the criminal activity and supplied the website's URL.

In certain embodiments, the electronic door locks and electronic access control systems that includes however not limited to Alarm systems to disarm and to arm alarm systems, electronic pad locks, electronic safe lock, And any other type of electronic lock or electronic access control device or system may be reconfigured and synchronized with the electronic identity security token. To use the identity security token's one time use security code to unlock the electronic lock or electronic access device or system instead of using a regular password.

In certain embodiments, the sex offender electronic locking GPS bracelet that may be electronically locked on the sex offender's leg, The GPS bracelet may have a built in electronic locking device that may by synchronized with the police department's identity security token. The GPS bracelet may also have a built in stun gun device that may automatically shock the sex offender, If the sex offender goes within a pre-determined distance of any restricted place. The police may enter their identity security token's security code in to the sex offender's GPS bracelet's built in keypad to unlock the GPS bracelet. The police department may enter their identity security token's security code in to the built in GPS bracelet's keypad to stop the stunning device, From shocking the sex offender and to unlock the GPS bracelet to allow the GPS bracelet to be removed from the sex offender's leg. The police department may unlock the GPS bracelet at any time to be able to remove the GPS bracelet, From a sex offender's leg at any time by entering the police department's identity security token's security code in to the GPS bracelet's. Built in key pad and this GPS bracelet may be used with any kind of offender that has been released from jail or prison that includes however Not limited to sex offenders.

In certain embodiments, the X-ray Security camera that may be in the same security camera housing as the regular security camera, The home or business owner may only be able to review the regular security camera footage. The x-ray security camera footage may be encrypted and only the police electronic identity security token's security code may decrypt the encrypted x-ray security camera footage, The X-ray security camera footage may see through mask such as a robber's ski mask in a robbery and then that robber's face then may be searched using a facial recognition system and software in database such as the DMV database of the pictures of people that has been issued an driver's license and ID to be able to identify the robber by their facial recognition.

In certain embodiments, the same encrypted barcode system may be used to detect fake ids An ID scanning device that may detect Fake ids by reading the id's printed information that is on front on the ID card and then read the magnetic stripe or scan the barcode that is on the ID card, Then the id scanning device may then verify the information that is encoded on the magnetic strip or the barcode to verify that the id information matches the information that is printed on the id card exactly. If the id information that is encoded on the id's magnetic strip or barcode is not exactly the same information that is printed on the id card then this may indicate that the id is fake, The id scanning device may be connected to an online database that may have an database records of people that has died their first name, last name, date of birth and date of death then the id scanning device may scan all IDS for that first name, last name, date of birth on an id that was issued after the date of death of that person. To detect an identity thief that is using an stolen identity of an dead person. The id scanner and database system may search for an name change or marriage records for an dead person's first name, last name and birth date and then the changed new name may be stored in the database that the id scanner is connected to, Then the id scanner may scan ids searching for the new name and the birth date to detect the stolen identity/fake identity.

The id scanning device's built in camera may take an picture of the person that is presenting the id and then verify their picture against the picture that is on the id by using facial recognition camera and software to ensure that the person that is presenting the id is the same person as the picture that is on the ID. The id scanner may then connect to the id database in the state that issued that id to verify that the information on the id and the picture is exactly the same as on file for that id number. If the id's information does not match the information that is on file for that id number then this may indicate that the id is fake. The id scanning device may have an built in green and red light and when an fake id is detected the red light may turn on and when an real id is detected then the green light may turn on. There may be facial recognition cameras may be installed by that may be connected to the ID scanners via wire/cable that may verify the id as real and then scan the picture that is on the id and then take an picture of the person that is presenting the id, then the picture of the person presenting the id and the picture on the id may be verified against each other using facial recognition camera and software. Then if the facial recognition camera and software finds that the id picture and the picture of the person that is presenting the id is two different people then this may indicate that someone is attempting to use an another person's ID. and banks, retailers, Airports, clubs and any other place where id verification is needed may have an computerized system that may have a built in GPS system to be able to connect to the internet encrypted ID database, Even if the internet wire connection is cut or interrupted for any other reason or the wireless internet connection is interrupted due to an person using a WIFI jammer or for any other. Reasons that may happen in an emergency including man made emergencies including however not limited to an person using an WIFI jammer or an natural emergencies, and the ID barcode scanner and encrypted computerized system may have an internal back up battery that may last at least fourteen days and that may automatically kick in if the AC power is disconnected or goes out due to an storm in the area or for any other reason.

In certain embodiments, the person may be notified about current scams including however not limited to the Fake DEA agent scams by displaying the current scams on the LCD display screen and the person must press an confirm or accept button to certify that they read and understood the current scams when they are being issued an identity security token/key, And the facial recognition camera may make sure that the person that is being issued the identity security token/key is the person that is reading and confirming that they understand the current scams.

When person is being arrested the person that is being arrested may speak in to a voice recognition microphone or their face may be scanned by an facial recognition camera and transmitted wireless to the police station to verify, The identity of the person and the person's identity may be transmitted back to the police car that may display the person's real name, date of birth, any crimes that the person is wanted for or wanted for questioning. And the picture of the person may be displayed on the police car's laptop or an another LCD display screen that may be portable or installed in the police car, Then the police station knows the real identity of the person that is being questioned on scene or being arrested just in case the person escape before being transported back to the police station.

In certain embodiments, a person may supply their identity security token/key's id number and security code to be used to obtain and verify their identity, By the police officer entering that person's identity security token/key's id number and security code in to the internet database to obtain and verify that person's real identity.

In certain embodiments, the person may be able to go online and log in to an database by entering their security token/key's ID number and security code and then that person may be able to print a temporary replacement new Driver's license, State ID, Passport and any other kind of ID online to be used with the security token/key to verify the person's identity.

The security token/key may be made with an internal encrypted memory that may store the person's ID's and any other information that has a numbers, letters or numbers and letters, The security token/key may send/transmit the encrypted Id, or other information to a scanner or reader after identity verification and then the ID's and other information may be displayed on a LCD display screen that may be connected to the reader or scanner and then the person may select the ID or other information to use at that time. A person may access an internet database and log in using their identity security token/key's id number and security code and then that person may be able to print an temporary driver's license, states id, firearms card, credit card, debit card or payment card or other identification form at any time, To allow a person to be able to print a temporary driver's license, states id, firearms card, credit card, debit card or other payment card or other identification form instead of making a person stand in line.

Two pictures of an run away, abducted, missing or kidnapped kid or adult one may be a regular picture and the other picture may be an age progressed picture of them of the age that they would be currently and the id scanner may capture the id picture of the id that is being scanned/captured and then the facial recognition camera may take an picture of the person that is presenting the id and then, The facial recognition id system may verify that the person pictured in the id is the same person that is presenting the id by using facial recognition software and to verify that the person is the person that is pictured on the presented id and then the person's picture may be verified against the database record on file for that id number. To ensure that the picture matches the person's picture that the id was issued and then the facial recognition picture that was taken of the person that is presenting the id may be verified, Against run away, missing and kidnapped kids and adults to verify that person is not the kid or adult that have run away, went missing or have been kidnapped.

In certain embodiments, Credit and debit cards may use the same encrypted barcode that may be encoded with the credit card or debit card number and an security code that may function in the same way the encrypted money bill barcode may function to detect counterfeit money bills. Credit card companies may allow customers to print one time use credit cards by accessing their credit card account online by entering their identity security token/key's id number as their user id and then enter their identity security token/key's security code as their password and then that authorized person may be able to print an one time use credit card.

In certain embodiments, Banks may allow customers to print out one time use debit cards using their regular printer by accessing their bank account online by entering their identity security token/key's id number as their user id and then enter their identity security token/key's security code as their password and then that authorized person may be able to print an one time use debit card or the bank account, Authorized user may go in to their bank and enter their identity security token/key's id number and enter their identity security token/key's security code and then the bank may print an one time use debit card for that authorized person to use.

In certain embodiments, some banks also issue credit cards as well as debit cards and the banks that issue credit cards may also allow customers to obtain an one time use credit card after their identity has been verified by the authorized person entering their identity security token/key's id number and identity security token/key's security.

In certain embodiments, the system may protect the homeless and needy people from other people that are not homeless or needy from taking the needed donated food and clothing items away from them just because the people that are not, Homeless or needy are just too much of an cheapskate to go to a regular store and purchase clothing or go to a grocery store and purchase food. Homeless and needy people may be verified and issued an picture id card that may have an id number that may be registered/linked to an identity security token that an homeless person may use to identify themselves as an verified homeless or needy person, To allow donation centers that receive food and/or clothing donations to restrict food and clothing to be sold or given to people that are not homeless or needy and by restricting the sale of donated clothing to people that are homeless or needy.

This may prevent people that are not homeless or needy from receiving food or clothing or from purchasing food or clothing from the donation center and there may be, Price limitations on how much the donation center may charge for any donated food or clothing item to prevent high prices that is deemed too high for the homeless or the needy to be able to purchase the food or clothing item.

In certain embodiments, Kid's ID card system id number may be registered/linked to an identity security token/key and that kid's voice may also be entered in to an database of voice samples of people that was issued an identity security token/key.

When an illegal person may be found to be in the United States illegally then that the person may have a choice to either be deported back to the country where they are from or pay a fine, and the fine may be a high dollar amount fine such as two hundred thousand dollars that may be paid every year in small installments of a few hundred dollars until the full fine dollar amount is paid in full.

The money may be used to feed the hungry and supply clean and safe drinking water to the entire world because the united states is responsible for supplying food to the hungry and to supply clean drinking water for the entire world because the united states have their nose in to everything, So this should not be any different. Illegal persons that would like to be a part of the united states should be the people that fixes a few of some of the biggest problems in the county where they want to be so badly and they broke the law by gaining illegal entry in to The united states as well as the rest of the world because the united states wants to be a leader then leaders fix problems.

Some of the Fine money may go towards paying off the national debt so the united states may get out of debt sometime in the near future or any time in the future.

In certain embodiments, the A person that is being served with court documents may not be able to renew their driver's license, state id card, firearm's license or any government issued identification in any state until they accept, Delivery of the legal court document at the DMV or at the automated DMV machine, The legal document with their court information may be displayed on an LCD display screen at the DMV or at the automated DMV and there may be a facial. Recognition camera to identify that the person that is by the LCD display screen is the person that is being served then after that person that is being served has been served electronically then the LCD display screen built in printer or the automated DMV's machine's, Printer may print the court document information for that person's record then the person may be able to renew their driver's license, states id, state id card firearms card or any other government issued identification in any state.

In certain embodiments, the age of consent sexual test and sexual picture ID system the age of consent for having sex should not have anything to do with age however it should have be more focused on if the persons involved in the sexual activity, Knows and understands the risks of having sex and how to protect them self from these risks involved in having sex and the risks of meeting people online that they do not know and meeting people in person that they do not know. The age of consent just makes underage girls more at risk because they may still have sex however when there is a problem they may NOT ask any questions to anyone if they need help because currently they may be in fear that they may get into trouble as well as their sexual partner, So at the end of the day the world is now worst off and the time and money wasted on courts on underage sex may be better spent on going after criminals that break laws that have hurt someone or forced someone to do something that they do not want to do such as unsolved cases of women that is under or over the age of consent being raped meaning forced to have sex.

A test that a person that is under the age of consent for sexual activity in their state that they may take to be able to legally have sex with anyone of any age in their state while still being under the age of consent by passing and by passing the sexual test that may exclude them from the age of consent law, The person may also may be legally allowed to pose naked in a picture and movies the test may be multiple choice and the test questions may involve sexual relented questions that include. However not limited by intercourse sex, oral sex and anal sex sexual questions as well as birth control, HIV and other sexual transmitted diseases testing, condoms, the morning after pill, sexually transmitted diseases and understanding the social risks of being naked in a picture or video.

Anyone that passes the Sexual test may then be allowed to purchase the morning after pill regardless of their age by showing their sexual picture ID card that may be issued to them after they have passed the Sexual test. The sexual picture ID card id number may be registered/linked to that person's identity security token/key to verify their identity a person may scan, A picture of the person or save a picture of the person on to their computer and up load it to the database and then the database may search for that person in the database, By the encrypted. Database using facial recognition software and if there is facial recognition match in the database then this may indicate that person has passed the sexual test and may legally have sex with anyone of any age and the person performing, The search may be able to print out a confirmation page that verifies that the girl or boy has passed the sexual test and may legally have sex with anyone that is any age that they want to have sex with and that they may be naked in pictures and movies and the confirmation page may have the person's sexual Id number, name and date of birth.

There are currently no systems to test someone about how much they know about sex instead there are laws currently in place that makes it against the law to have sex with someone before a certain age or with someone over a certain, Age no matter if the persons that are involved in the sexual activity understands what exactly sex is and what the risks of having sex is or not however a student's teacher or other authority figure should not be able to have sex with a person under the age of consent. Even if the person have passed the sexual id card system because of their authority however an teacher that teaches at the same school may still have sex with the underage person that is a current, Student at that school if that person have passed the sexual id test and has an valid sexual id picture id card if the teacher does not currently and may never teach the student. And is currently and may never be involved in the grading process of that student an age requirement to be able to take the sexual test to be issued an sexual picture id, Card to an age that is currently below the current age of consent such as age fourteen and the sexual test may require an parent's signature to allow their kid to take the sexual test and allow them.

To be issued an sexual picture id card if they pass the sexual test this system may work good because girls and boys both understand sex and other adult, Related things at different, Ages and a set age requirement is unfair because someone at age thirteen may understand more than a person that is even eighteen years old.

Age requirements for sex Does Not protect young people It really most likely may make more young people become sexual abuse victims because the young person never learn about sex when they are having sex with people that is over eighteen years old even while it is illegal and how to have sex safely.

In certain embodiments, a people that may be mentally retarded or have an another condition that appears their understanding of things that an normal person understands may not be allowed to have an sexual picture id, People that passed the sexual test and have been issued a sexual pictured id card may be expanded to allow the person to also share naked pictures of themselves with other people or just the person that they are having sexually activity with. The person may read the written sexual test. The person may answer the sexual test questions. Then the person's sexual test may be scored.

People that have past the sexual written test may be issued an sexual picture ID card to identify the people that have past the written sexual test, The person's information may also be entered and stored in to an database system to identify people that have past the written sexual test.

In certain embodiments, Porn/naked pictures and movies facial recognition system that may work with the sexual picture id system and an person may enter the production or the release date if the production date is unknown, And the facial recognition system may scan the faces of all the people that is in the porn movie and verify their picture against their ids picture that is on file in the id database to verify that the person is currently and was over the legal age. For being or posing nude in a movie or for a picture at the time that the movie or picture was produced or if the production date is unknown then the released/discovered date, To prevent people, companies and porn movie companies from trading or making money off of selling porn movies and/or pictures of underage girls. Then after an person that is posing. Naked in a picture or movie is found then that person's face may be verified against the sexual picture id card system database.

By using facial recognition software and then if that person is found to have an valid sexual id picture id card then that person may be excepted from the age requirement.

In certain embodiments, the Bac key vault that may have a built in breathalyzer and a built in keypad and a person may lock their car keys in to the Bac key vault and close and lock the key vault then only authorized user's that security token/key's ID number is registered, to the Bac key vault may be able to unlock the key vault only after breathing in to the BAC device and if the person is over the legal limit. then the key vault may not unlock and if the person is under the legal limit then the authorized user may unlock the Bac key vault by entering their security token/key's security code on the Bac key vault key vault. The bac key vault may be made of steel or any other material that may block smart keyless keys from transmitting or transponder and/or receiving signals from the car to smart or control the car in any way

The Bac key vault can have a transponder that may be locked on to the car key ring by using a special key and the transponder or transponder may communicate with a transmitter receiver or transponder reader to verify that the car keys are inside. the bac key vault and the BAC key vault may also have a built in GSM and GPS devices the GSM device may call a parent or other pre-set number to notify them when the Bac key vault is closed and locked, and if the car keys are inside the Bac key vault and when the person fails a BAC test and supply the exact GPS location of the person that failed the Bac test. The BAC key vault may be reconfigured with any kind of built in biometric that include however not limited by a finger print reader, eye recognition camera, facial recognition camera.

If any biometrics is used for the Bac key vault then eye recognition or face recognition camera that require the person eye or face to be up against the device, while breathing in to the BAC test to ensure that the authorized person is the person taking the BAC test most likely be the ideal biometrics however any kind of biometrics may be used.

In certain embodiments, the OBD car theft prevention device that may plug in to the car's OBD port and the OBD car anti-theft device may have an built in ultrasonic distance calculation intruder detector that may detect the distance of an person or object, And then record that distance to the internal memory when the ultrasonic distance calculation intruder detector is being armed and then once the ultrasonic intruder detector is armed. Then the ultrasonic distance calculation intruder detector may calculate the distance of that same person or object and if the distance changed and then the OBD anti-theft built in siren may sound, the OBD Anti-theft device may send an encrypted signal to the car's on board computer telling the car's on board computer that someone is attempting to steal the car and the car may shut down.

The car's on board computer to prevent the car from being started even if the thief has the car keys to the car the OBD anti-theft device arm and disarm remote control that may have an remote control id number, To identify that remote control from an another remote control and the remote control id number may be registered/linked to the car owner's or authorized driver's identity. Security token/key's id number and the OBD anti-theft device may then be synchronized with the authorized person's identity security token/key and the remote control may send encrypted, Arm and disarm signals to the OBD anti-theft device to arm and to disarm the OBD anti-theft device and the OBD anti-theft device could be used to unlock And to lock the car doors as well as arm and disarm the OBD anti-theft Device at the same time. And when the car doors are locked then the OBD anti-theft device may be automatically armed and when the car door locks are unlocked then the OBD anti-theft device may be automatically disarmed.

The authorized person may be required to enter their identity security token/key's security code in to the OBD anti-theft remote controller's built in keypad to verify their identity before they may be able to disarm the OBD anti-theft device and the OBD anti-theft device may also be programmed, To require the authorized person to enter their identity security token/key's security code in to the OBD anti-theft remote control to arm the OBD anti-theft device and to lock the car doors if desired by authorized persons. And if the car owner or authorized driver accidentally triggers the OBD anti-theft device then the authorized car owner or authorized car driver may use the OBD anti-theft remote controller and enter their identity, Security token/key's security code and then press disarm on the OBD anti-theft device's remote control and then the OBD anti-theft device may reset the OBD anti-theft device and may allow the authorized person to start the car with the car keys.

The OBD car security device may use any kind of laser alarm, any motion or intruder detection device or system that includes however not limited to Proximity sensors/detectors and ultrasonic distance calculation intruder detectors and an person's identity security token/key's id number may be registered/linked to an car keyless entry keypad security system, To allow the authorized person to use their identity security token/key's security code as the security code to unlock and lock the car doors if the keyless entry key pad car security system is wired then the car security keyless keypad system may have an id number to identify the car keyless keypad security system from an another car security keyless keypad system and the id number may be registered/linked to the authorized person's identity security token/key.

There may be a motion or intruder detection device installed on the car's steering wheel or any other place inside of the car that may be connected via wired or transmit an encrypted signal to the OBD device, That is plugged in to the car's OBD port however if the device transmits an encrypted signal to the OBD device then the OBD device may be required to have an signal receiver.

In certain embodiments, the a battery operated device/system that may have an id number to identity the device from an another device and the device's id number may be registered/linked to an person's identity security token/key's, Id number and the person may enter their identity security code in to the device's built in keypad to turn the device on or off detect and fight bad spirits that include however. Not limited to demons the device may have an built in electromagnetic pulse detector, an built in priest blessed holly light, an built in speaker, an built in key pad and an built in voice recorder.

The voice recorder may record, The sounds around the device when the device is triggered and an built in encrypted internal memory to store voice recordings of prays and any other audio files. That may be automatically played when the device is triggered and an built in water sprayer that may automatically spray holly water when the device is triggered when electromagnetic pulse detector reading has indicated, That there is a spirit or demon that is nearby,

The battery operated device may be enclosure in a metal enclosure or enclosure in other material to prevent bad spirits or demons from turning the battery operated. Device off or otherwise tamper with the device the battery operated device stand that the device is welded on to may be bolted to the floor, wall or ceiling to prevent the device from being, Lifted or moved and an ignition system may be added to the system to be able to burn white sage or other burnable items or things that may help rid the place of the bad spirits and demons.

In certain embodiments, the device/system may use AC power instead of using one time use batteries and the device/system may use an rechargeable battery. Airplane high security fire and bomb proof safe that may have an id number to identify the safe from an another safe and the safe's id number may be registered/linked to the authorized, Person's identity security token/key's id number and the authorized person may enter their identity security token/key's security code in to the safe's built in key pad to lock and to unlock.

The safe however the safe may be required to get an authorization encrypted signal from the airport before even the authorized person may open the safe an airplane passenger may place, All their liquids and other restricted items in to the safe and close the door and there may be an encrypted safe locking signal transmitter installed by the X-ray belt when the safe passes the locking signal transmitter or transponder. The encrypted locking signal may automatically lock the safe and the safe may not be able to be unlocked until that person brings the safe outside the restricted/secure area of the airport, Where there may be an encrypted unlocking signal transmitter or transponder installed at the exit from the restricted/secure area of the airport that may transmit an encrypted unlock signal to the safe and may allow the safe to be opened. This safe may allow people to carry on liquids of any size without the risk of danger from someone bringing flammable or explosive liquids because the safe may be fire and bomb proof.

Because allowing people to even carry on even the smallest amount of liquid that could be flammable or explosives may be very deadly because what if seven people that are traveling together on the same flight go through, security with the max amount of liquids allowed to be carried on an airplane by one person and then all seven of them meet up in an bath room or some other place in the airport to mix the explosives to make a bigger explosive device. And instead of a safe just for the liquids and other restricted items the entire carry-on bag may be an metal locking safe to prevent access to anything that is in the carry-on bag, While on in the airports restricted area and on the airplane, Because the person may have other dangerous items that have been overlooked or even was deemed not an security threat.

People may be able to rent an fire and bombs proof luggage locking enclosure device at the airport to be able to carry on any item(s) on to an airplane that is allowed in checked baggage that goes under the airplane.

In certain embodiments, the airlines may give out free lotion and hand sanitizer because this two items are the most two common items that would be wanted by people on the airplane during the flight and airports should use the currently installed full body x-ray scanner instead of the metal detectors to detect weapons and bombs because plastic weapons, Are not detectable by metal detectors that include hover not limited by the ABS knifes and to make people more maying to go through the airport security x-ray scanner the president of the united states and wife and kids should go through the full body x-ray scanner and post the pictures online for all to see to show people that it is really no big deal to go through the airport security full body x-ray scanners if it is really not a big deal after all.

In certain embodiments, the a baby bottle and kid's Sippy cup that may have an electronic locking device that may automatically lock the electronic locking baby bottle and Sippy cup when the baby bottle or Sippy cup is brought past an automatic locking signal transponder or transmitter that may automatic lock the baby bottle that may prevent, The baby bottle from being opened until the baby bottle or Sippy cup is brought out of the secured area where there may be built in unlocking signal transponder or transmitter to automatically unlock the baby bottle and Sippy cup to allow the baby bottle and Sippy cup to be opened.

The baby bottle or Sippy cup may have an electronic locking device that may have an id number to identify the baby bottle or Sippy cup from an another baby bottle or Sippy cup and the id number may be registered/linked to an authorized person's identity, Security token/key's id number and the baby bottle or Sippy cup may have an built in keypad for the authorized person to lock and unlock the baby bottle and Sippy and when the baby bottle or Sippy cup is not in a secure area of the airport.

In certain embodiments, the baby bottle and Sippy cup electronic locking system may be used with any cup, glass or container that includes however not limited to a an open-able and closeable drink containers or left over food containers, The electronic locking system may be reconfigured with a high security key lock or any type or kind of biometrics including however not limited, To finger print scanners, voice recognition microphone and facial recognition camera to allow a person to lock the container and use it in airports or the airports may limit this to the baby bottle and Sippy cup and the drinking containers may be made to not allow too much liquids to be dispensed by an straw or by turning the drinking container over to try to spill out the liquid(s).

In certain embodiments, a similar system may be used to protect drinks at places that includes however not limited to bars and clubs and the cup may have an built in electronic or one time use date rape drug tester.

In certain embodiments, the Facial recognition spy camera glasses that may be battery operated with a rechargeable or replaceable batteries and the facial recognition camera glasses may have the built in facial recognition camera built in to the glasses, And the facial recognition camera glasses may have an built in GSM device, GPS device and an built in encrypted internal memory may have pictures of wanted and missing persons and when a wanted person or missing person. Has been detected by the facial recognition camera and then the picture of the wanted or missing person the name of the wanted or missing person and exact GPS location may be transmitted, To an wanted and missing person response command center and then the police may go to that exact GPS location to attempt to locate that wanted or missing person around the GPS location.

The facial recognition camera may be used by police and the facial recognition camera may have an built in microphone to allow people to verify their identity by voice recognition.

In certain embodiments, A electronic choking device that may be synchronized with the person's identity security token/key the choking device may have an id number to identify the choking device from an another device and the device's id number may be registered/linked to an person identity security token/key's id number and the identity, Security token/key's security code may used just like an password to turn the choking device on and the choking device may tighten around a person's throat to give that person a high and the choking device may be connected. To a wired remote control that may have an built in encrypted internal memory, keypad, siren, built in red light, GSM device, GPS device, green light and an built in “I am alright” button remote control and the choking device may tighten around, The person's throat to give that person a high and then when the red light flashes and beeps then the person may be required to press the I am alright button to tell the choking device that they are alright and if the person does not press.

The I am alright button when the choking device red light is flashing, within ten seconds then the choking device may automatically untighten around the person's neck and the red light may continue to flash and then after twenty seconds of no response, Then the built in GSM device may call the police and play an recorded message may be played to tell the police that there is someone in trouble and they are dying and the GPS device may supply, The exact location of the person that is dying and after the police are called then the choking device may sound a siren to cause attention.

In certain embodiments, the Pay what you can food places such as the pay what you can Panera should use an picture id card that may be issued to people ho really need a free meal to prevent people from taking advantage of free food and taking, Away the free food from people that really needs the free food the picture id card may have an encrypted barcode that may be encoded with an id number and an security code and the id number and security code. May be on file in an database to verify the id number and security code against the security code that is on file in the database for that id number, And if the security code matches, The record on file for that id number then this may verify the id as real and if the security code does not match the security code on. File for that id number then this may indicate that the id card is fake the picture id card's id number may be registered/linked to an person's identity security, Token/key's id number and when the id card id number barcode is scanned or when the id number is entered then the authorized person may enter their identity security token/key's security code to verify their identity.

All fast food places that includes however not limited to McDonalds should accept the homeless and poor person photo id card and give the homeless/poor person an free meal. Homeless and poor people that have been issued an picture id card to get free food that was talked about above in number one hundred and sixteen and the homeless person or poor person may present their picture id card to an city bus driver and the picture, Id card may be scanned by an barcode reader that may be connected to the database system that may verify the encrypted barcode encoded security code. Against the security code that is on file for that id number in the database and then if the security codes match then this may indicate that the id is real. and there may be an facial, Recognition camera that may verify that the person that is presenting.

The id card may be the same person and then that person may then be able to ride the city bus for free to go to any homeless shelter, food kitchen or other known free food places to ensure that the homeless or poor person has an way of getting to the place to get free food or shelter. There may be an keypad on the bus to allow the homeless person to use their identity security token id number and security code to verify, Their identity and the bus may have any other biometrics camera, scanner or reader that includes however not limited to an finger print scanner/reader, voice recognition microphone and vein recognition.

In certain embodiments, the Finger print scanners/readers may be used however finger print scanners/readers may be fooled by an person using an cast of an authorized person's finger print, As talked about below in number one hundred and eighteen. The homeless or poor person free bus ride programs may be expanded to allow homeless people and poor people to be able to warm up on the bus when it is cold outside, There may be a system in place that may be that if the outside temperature drops below a certain temperature then the homeless or poor person with an picture id card may ride the bus for free.

People should be allowed one free meal and one free ride on public transit per person even before an photo ID card has been issued or even been applied for to give the person a meal and if the person have applied for an id photo card and have not been accepted or denied then that person may receive meals until they have been denied, However the person may look in to an facial recognition camera that may put their picture in to an facial recognition database to verify at an later date that person was given a meal and did not get or apply for a photo id card.

In certain embodiments, the an electronic kid leash locking device that may have an built in electronic locking system and an built in keypad, built in encrypted internal memory that may store pictures of kids or adults and the electronic kid's leash with have an id number to identify the electronic kid's leash form an another electronic, Kid's leash and the electronic kid's leash id number may be registered/linked to the parents or authorized person's identity security token/key's id number and the parent may enter their identity security token/key's security code in to the electronic kid's leash built in keypad to. Activate and lock and to deactivate unlock the electronic kid's leash locking cuff that may lock on to an kid's wrist and the another cuff with be locked on to the parents wrist and the cuffs may have an built in pulse monitor, alarm contact or other tamper alarm to detect the, Electronic cuff being removed without authorization from the parent or authorized person and this may trigger an alarm and may report the kid as missing and the electronic cuffs may have an anti-cut alarm cable that may separate the cuffs from each other and when the locking system. Is activated that may automatically turn on the alarm system and if the cable is cut then the strobe light and siren may sound an alarm and when the cable is cut then the electronic kid leash may automatically transmit an signal with the electronic kid's leash id number with the kid, Or kid's picture or the system may connect to an database system to locate the picture of the kid or kids that is registered/linked to that kid's leash id number in the database to the dual turnstile security system to automatically report their kid missing. That may prevent anyone from leaving the mall or retail store with that that kid.

In certain embodiments, the there may be dual turnstile locking Inner turnstile that may have an security bay in between the inner turnstile and the outer turnstile that may have an built in people counter in the security bay and the missing kid and adult system installed at the mall or retail store may lock the, Inner turnstile after an kid or adult is reported missing to mall or retail store security and then all the exists inner turnstiles may be automatically locked and there may be a facial recognition camera and he turnstile security system may have an built in scanner with an built in transmitter receiver to receive pictures from.

The electronic kid's leash encrypted internal memory or the kid's leash id number and the scanner that may Access the database to locate the picture of the kid or kids that is on file for electronic kid's leash id number or the security guard/officer may scan a picture of, The missing kid or adult and there may be an built in facial. Recognition camera and people counter that may be built in to the security bay by the inner turnstile and then people that enter the through the outer unlocked turnstile then the people may push an “verify” button. And then the outer security turnstile may automatically lock and then the number of people that have entered the security bay may be required to look in to the facial recognition camera to determine if that person is the missing kid or adult this system may prevent an kid or adult, From walking out of an mall or other store and may prevent the kid or adult from being kidnapped.

When an electronic kid's leash comes in to the mall or store the security turnstile may record the kid's leash id number and the electronic kid's cuff transmitter may. Transmit to the mall or retail store's turnstile security system every two seconds to ensure that the transmitter is transmitting properly and if the turnstile security system does not receive the signal from the electronic kid's leash every two seconds or other pre-set time period then an automated phone call and text, Message may notify the authorized person of a possible problem and the turnstile security device may try again to locate the kid's electronic leash id number and then if no signal is sent by that electronic kid's leash id number or if the kids goes within an certain pre-set distance of the turnstile security system without their parent then the turnstile security system may automatic report. The kid as missing and the inner turnstile may lock and the turnstile security system may scan all people that are leaving with an facial recognition camera to ensure that the kid or adult is not Leaving the mall or store.

The parent or authorized person may have their picture stored in, The electronic kids leash encrypted memory or in the database to allow them to leave with their kid by the facial recognition camera scanning the kid's face and then the parent's or authorized person's face and then the missing kid alert may be automatically cancel and the turnstile security device may unlock all of the turnstile.

In certain embodiments, a baggage x-ray system should be used to detect kids and adults hidden inside of baggage to prevent an kid or adult from being hidden inside of baggage and this is why the security bay that may be in between the inner and outer security turnstiles may have an people counter to ensure that all the people have been verified not, To be the missing kid or adult to be allowed to leave the mall or retail store the security turnstile system should not allow anyone with baggage to leave even if the missing kid is verified not to be one of those people exiting because the missing kid may be hidden inside of the baggage.

In certain embodiments, a similar system may be used with any person including kids at any place that includes however not limited to malls and stores and the electronic kids leash may have an Built in GPS device and instead of using an alarm cable the cuffs may be wireless, And the wireless electronic kid's bracelet cuff may automatically set a geo fence to that mall, store or any other place and the kid may be automatically reported missing if the kid walks an certain distance away from their parent or other authorized person.

In certain embodiments, a similar system may be used at any place that includes however not limited to retail stores and malls.

In certain embodiments, a similar system could also be used for animal/pet security to prevent animal/pet theft.

In certain embodiments, the An identity security token/key's id number may be registered/linked to an snow plow truck anti-theft system and the snow plow truck driver may be required to enter their identity security token id security code in to an built in keypad to be able to start the snow plow truck's engine and the snow suck and blow snow, Truck may have an snow plow installed on the front of the truck to scoop the snow and there may be an built in vacuum installed by the snow plow to suck the snow in and then blow the snow in to the truck's cargo area. And then once the snow is in the truck's cargo area the truck cargo area then the snow may be heated to melt the snow to turn the snow in to water by heating the snow to increase more space in the truck's cargo, Area for more snow to be turned to water and the snow that was turned in to water by melting the snow may be dumped someplace or pumped down the sewer where the rain water goes.

In certain embodiments, cars, SUVs and other vehicles that may have an trailer hitch receiver may have an snow plow device that may attach to the trailer hitch receiver to allow that car, SUV or other vehicle to plow the snow, There may be made an snow blower that attaches to the trailer hit receiver to allow the car, SUV or other vehicle to blow the snow.

In certain embodiments, the electronic dog collar and fence system may both have an id number to identify the electronic dog collar and fence system from an another electronic dog collar and fence system that may keep dogs in their yard without shocking the dog the electronic dog collar may be water proof and may have an built in transmitter receiver, transponder reader, keypad, Microphone as well as an built in USB port, encrypted internal memory and built in speakers.

The dog owner may register the electronic dog fence collar and, Id number to their identity security token/key's id number and then. The authorized person may enter their identity security token/key's id number in to the dog's collar built in keypad to enter in to recording mode and then the dog owner may say anything including any commands such as “No followed by the dog's name” and the recording may be repeated until the dog, Gets within a pre-set distance away from the dog's electronic fence to their dog and that command may be automatically played to the dog through the electronic dog's speakers when the dog that is wearing the electronic dog collar get within a certain distance of the electronic dog fence.

In certain embodiments, the Banks may have an dual turnstile and the inner turnstile may be locked and there may be an built in people counter, built in keypad and an built in facial recognition camera built in the security bay in between the inner turnstile and the outer turnstile and there may be an be an “verify” button, Installed near the facial recognition, Camera and the people that have entered through the unlocked outer security turnstile may then press the

“verify” button and then the outer security turnstile may automatically lock

The then the number of people that have been counted that entered the security bay enclosure may all be required. To enter their identity security token/key's security codes in to the built in keypad however for higher security the person should be required to look in to the facial recognition camera to verify their identity by the facial recognition camera connecting to the encrypted id database to be able verify, That person's identity by using the facial recognition camera.

If the person may be verified by facial recognition then that person may then be able to enter the bank and if someone cannot be verified by facial recognition then that person may not be able to enter. The bank to prevent bank robberies and if all the people's identity has been verified then the inner security door turnstile may unlock to allow the people to enter the bank and then after the people have entered, The bank through the inner security turnstile then the inner security turnstile may automatically lock and then the outer security turnstile may unlock to repeat the same process over and over again.

In certain embodiments, there may be an built in bomb detector in the turnstile security bay to prevent an 30 minutes or less type of bank robbery for happening in real life and prevent bank robbers themselves from using an explosive device to rob an bank.

In certain embodiments, an armor truck may have and dual turnstile built in to the door to prevent anyone except the armor car guards from getting in to the armor truck by the armor guard going in to the dual turnstile in to an security bay and the dual turnstile may automatically lock after one person has entered the turnstile security bay.

There may be an people counter installed in to the security bay to ensure that only one person has entered the turnstile, Security bay and then the person may be required to look in to an facial recognition camera to verify their identity before they may be allowed to enter the armor truck this system may prevent armor guards from opening the door and giving robbers time to overpower the armor truck guard and gain unauthorized entry in to the armor truck the back of the armor truck may have the same high security turnstile system.

In certain embodiments, the bank bullet proof glass may have an shock detector installed on the bullet proof glass to detect bullets or other objects hitting the bullet proof glass and then an bullet proof steel barrier may automatically pop up or slam down to block the window to add better bullet proof protection, And gun shot detector may be used to detect gun shots and to activate this system and this system may be used anywhere that is including however not limited to armor trucks.

In certain embodiments, the gun shot detector, fog dispensing machine, tranquilizing dispenser, Long Range Acoustic Device (LRAD) sonic weapon and heated inserts to prevent someone using an heat seeking camera or other device from locating people in the thick fog may be added to any device or system that includes however not limited to an turnstile security system and any alarm system.

In certain embodiments, the an electronic dating device for women and men that may have an encrypted built in signal transmitter, built in signal receiver device that may have an built in microphone, an built in speaker, keypad and keyboard that may be used by women and men to find their match to go on a date with and the women or man may connect, The dating device to their computer via USB port and access an encrypted internet dating database that may also may be used to meet people without the device and enter information about themselves and who they would like to meet and then that information entered in to the encrypted dating database may be sent to the device to be stored in the device's. Built in encrypted memory then when the device is turned on then the device may continually scan the area for transmitters that match who that person wants to meet and then once a match is found then both of the people may receive an notification on their devices to alert, Them that a match has been detected then the two of the people may talk to each other right then through the device's built in microphone and speaker or by typing using the built in keyboard.

The person may go talk to the person face to face and the dating device may have an id number to identify the dating. Device from an another dating device and the dating device's id number may be registered/linked to that person's identity security token/key's id number and the person may be required to enter their identity security token/key's security code in to the dating device's keypad to, Unlock the dating device to turn the dating device on and that person's identity security token/key's id number may be registered/linked to their dating account in the database and then the person may use their identity security token/key's id number as their user id and use their identity security token/key's security code as their password.

In certain embodiments, there may be an microphone or speaker or an microphone and speaker combo battery operated device that fits on the person finger to talk and/or listen, And the device may be used with any device or system including however not limited to cd players.

In certain embodiments, a No fly list database that may have pictures of people that are on the no fly list and by using a facial recognition camera at airport security to detect if the person is on an no fly list, And when the person is purchasing their airplane ticket the person may enter their driver's license or other government issued id number and the picture that is on file for that id may be verified. Against people's pictures that is in the encrypted no fly list database and if that person is on the no fly list then that person may not be able to purchase an airline ticket.

To prevent the need to verify, that the person that is purchasing an airlines ticket is not on an no fly list at the airport security check point because the verification that the person is not on a no fly list should take place right before the airline's ticket is purchased, And if that person is on the no fly list then they may not be able to purchase an airline's ticket and there may be an face recognition camera that may be built in to an barcode scanner that an person may scan their boarding Pass's barcode on the barcode. Scanner that may read the encrypted barcode encoded id number and security code to verify the boarding pass id number and security code against the boarding pass database.

To verify the scanned boarding pass's security code against the security code, That is on file in the boarding pass database to ensure that the security codes match and then if the security codes do not match then this may indicate that the boarding pass is fake and then the LCD display screen may display “denied” in color red and flashing. And if the boarding pass is verified as real then the LCD display screen may display “Verify identity look in to facial recognition camera” and then after the person looks in to the facial recognition camera then the facial recognition camera system may verify, That person's picture against the picture that is on file for the id number that the person used when they purchased their airline's ticket when they verified themselves as not being on the no fly list.

In certain embodiments, the retailer or bank may have a barcode scanner that may be connected to the database to prevent counterfeit money bills and to detect stolen money bills by registering money bill serial numbers to a retailer at the time of a transaction such as when a customer is making a purchase and the customer's total is twenty five dollars then the database system may require the retailer to scan the money bills encrypted barcode until enough money bills have been scanned to calculate twenty five dollars or more.

Then that money bill serial numbers may be registered to that retailer in the database. Then the database may then calculate the customer's change that is due and then the retailer may only be allowed to unregister that exact dollar amount of the database to be given to the customer as their change.

Banks may have a check scanner and a withdrawal slip scanner that may be connected to the database and the check and withdrawal slip scanner may read the written or printed dollar amount that is written or printed on the check or withdrawal slip and then that bank may only be allowed to unregister that exact dollar amount of the check or withdrawal slip to be given to the bank customer.

It should be understood, of course, that the foregoing relates to exemplary embodiments of the invention and that modifications may be made without departing from the spirit and scope of the invention as set forth in the following claims.

What is claimed is:

1. A method for authenticating an object, comprising:
displaying an optical machine readable code comprising information on the object, wherein the information comprises a unique number and a predetermined data;
providing a database comprising a plurality of associations between at least one unique number and the predetermined data linked to each unique number;
entering the optical machine readable code into the database; and
matching the unique number of the optical machine readable code with the unique number of the database to determine whether the predetermined data of the optical machine readable matches with the predetermined data associated with the unique number of the database.

2. The method of claim 1, wherein the optical machine readable code is a barcode.

3. The method of claim 2, further including encrypting the barcode information in an encrypted barcode, wherein the database is configured to decrypt the encrypted barcode.

4. The method of claim 3, further including providing an authentication device configured to scan and remotely communicate the optical machine readable code the database.

5. The method of claim 1, further including providing a masking surface over a portion of the object, wherein the masking surface prevents the optical machine readable code from being copied.

6. The method of claim 1, wherein each association includes a registered custodian and further including altering the registered custodian for each object involved in a bilateral transaction between at least one custodian.

7. A system for authenticating an object, comprising:
a computer having a user interface; and
a program product comprising machine-readable program code for causing, when executed, the computer to perform the following process steps:
receiving entered information from an optical machine readable code displayed on the object, wherein the optical machine readable code comprises a unique number and a predetermined data;
sending the information to a database, wherein the database comprises a plurality of associations between at least one unique number and a predetermined data linked to each unique number; and
matching the unique number of the optical machine readable code with the unique number of the database to determine whether the predetermined data of the optical machine readable matches with the predetermined data associated with the unique number of the database.

8. The system of claim 7, wherein the optical machine readable code is a barcode.

9. The system of claim 8, wherein the barcode information is incorporated in an encrypted barcode on the object, wherein the program product decrypts the encrypted barcode to access the barcode information.

10. The system of claim 7, further including an authentication device configured to scan and remotely communicate the optical machine readable code to the database.

11. The system of claim 7, further including a masking surface over a portion of the object, wherein the masking surface prevents the optical machine readable code from being copied.

12. The system of claim 7, wherein a plurality of associations includes a registered custodian and further including the program product step of altering the registered custodian for each object involved in a bilateral transaction between at least one custodian.
